(19) United States
(12) Patent Application Publication
(10) Pub. No.: US 2003/0192174 A1
(43) Pub. Date: Oct. 16, 2003

(54) Optical fiber device manufacturing systems, apparatuses, and methods

(75) Inventor: Sandesh Devegowda, Elkridge, MD (US)

Correspondence Address: CORVIS CORPORATION, INTELLECTUAL PROPERTY DEPARTMENT, 7015 ALBERT EINSTEIN DRIVE, COLUMBIA, MD, 210469400

(73) Assignee: ATTN: Intellectual Property Department, Corvis Corporation

(21) Appl. No.: 10/119,652

(22) Filed: Apr. 10, 2002

(51) Int. Cl. G02B 6/02; G02B 6/16

(52) U.S. Cl. 29/825; 385/123; 29/566.2; 29/742; 29/748

(57) ABSTRACT

The present invention relates to systems, apparatuses, and methods for the automated manufacture of optical fiber devices including a fiber magazine and a plurality of fiber cassettes within the magazine. The cassettes include alignment members and optical fiber in which the devices are to be formed. A plurality of work stations include assemblies for processing the fiber in the cassettes and reciprocal alignment structures corresponding to the alignment members of the cassettes.

### CROSS-REFERENCE TO RELATED APPLICATIONS

Not Applicable

### STATEMENT REGARDING FEDERA118Y SPONSORED RESEARCH OR DEVELOPMENT

Not Applicable

### BACKGROUND OF THE INVENTION

The present invention is directed generally to the manufacture of optical fiber components. More particularly, the invention relates to systems, apparatuses, and methods for the automated manufacture of optical fiber components.

The development of digital technology provided the ability to store and process vast amounts of information. While this development greatly increased information processing capabilities, it was soon recognized that in order to make effective use of information resources it was necessary to interconnect and allow communication between information resources. Efficient access to information resources requires the continued development of information transmission systems to facilitate the sharing of information between resources. One effort to achieve higher transmission capacities has focused on the development of optical transmission systems. Optical transmission systems can provide high capacity, low cost, low error rate transmission of information over long distances.

Optical communication systems transmit optical signals over optical fiber. As the demand for transmission capacity increases more information must be transmitted over optical fibers. This demand has lead to the development of wavelength division multiplexed (WDM) systems where multiple information carrying optical wavelengths are multiplexed together on a single optical fiber. The WDM signals are demultiplexed, switched, and otherwise processed and manipulated to transmit large amounts of data. Various devices have been developed to process and manipulate WDM signals. Optical fiber devices are an important type of optical device that are based upon optical fiber. Optical fiber devices are easily integrated into optical fiber communication systems. Examples of optical fiber devices are fiber Bragg gratings (FBGs), DFB fiber lasers, couplers, modulators, and Mach-Zehnder interferometers. A FBG can be used to filter WDM signals, which is a very import function in WDM systems. The manufacturing process for FBGs provide an example of the manufacturing process for optical fiber devices. Therefore, the manufacturing process for a FBG is discussed to illustrate the present invention. The present invention can be used to manufacture other types of optical fiber devices as well.

Holograpically induced gratings have become well known in the art. Holographically induced devices are generally produced by exposing an optical fiber to an interference pattern produced by intersecting radiation beams, typically in the ultraviolet frequency range. The intersecting beams can be produced interferometrically using one or more radiation sources or using a phase mask.

The manufacture of devices may include the following steps: hydrogenation, stripping, writing, annealing, recoating, packaging, measuring, and baking. Each step is briefly discussed below.

Hydrogenation involves diffusing hydrogen or deuterium into optical fiber that increases the sensitivity of the fiber to the ultraviolet light used to write the grating. The increased sensitivity results in better reflection and bandwidth performance for the resulting device. Hydrogenation typically occurs in a chamber that controls the temperature, concentration, and pressure of the hydrogen. Usually, a large amount of fiber, either cut to lengths or still on a spool, is hydrogenated all at once. While hydrogenation improves the performance of devices, hydrogenation is not required; therefore this step is optional.

Optical fibers have a core with an outer cladding and jacket. In order to irradiate the fiber core and write the grating, this jacket must be removed or stripped. A stripping tool strips the coating off of the fiber. The stripping tool is used by holding the fiber at one end and running the stripping tool over the section to be stripped. After the fiber is stripped it is cleaned. These operations are often performed manually.

Once the fiber is stripped it is ready to be written. The fiber must be precisely mounted in the writing machine. Both the position and tension of the fiber must be set and controlled. The writing machine radiates the fiber with ultraviolet light to write the grating. The loading and mounting of the fiber presents a great challenge as the fiber is manually loaded into the machine. Variations in the loading will affect the final yield and performance of the devices because the writing process is sensitive to mechanical stability and variation in the location of the fiber.

After the device is written, the reflection characteristics of the device may be measured. Next, the device may be annealed. Annealing involves a controlled heating of the device and is also known as accelerated aging. Annealing helps to set the characteristics of the device. The temperature and time of the annealing depends on the fiber type, device type and specification, and measured device parameters, if available. The device can be heated in a variety of ways including, for example, a heat gun, hot gas or liquid, heater block, or heated metal plate. After annealing, the device is measured, and if the device is outside the device specification, the device is again heated, because heating a device can shift the reflection wavelength downward. This is called trimming. Trimming parameters depend upon the device, fiber type, and the amount of wavelength shift required. Trimming can be repeated for a set number of cycles or until the device is within specification.

Next, the annealed device may be recoated. The device is placed in a mold and coating material is injected into the mold. A curing lamp cures the coating material, and then the molds are opened and disengaged. The recoated device can be measured again to ensure that the device still is within specification. The molds used are typically made of two pieces. Mating and alignment of the molds is difficult resulting in failed devices. Curing is often done manually and adds variability to the resulting devices due to shrinkage of the coating material.

The recoated device next may be packaged. A typical package is a long slender quartz package with a slot. The operator positions the device within the slot, typically using a microscope because the fiber is very small. The operator places a tension on the device. This tension is typically zero, but other values of tension may be applied to shift the reflection wavelength into specification. Next, adhesive is applied at either end of the package over the fiber to securely fasten the device to the package. The operator cures the adhesive using a heat gun. Many of these steps are performed manually, which results in increased device variability and decreased device performance.

Finally, the device may undergo baking and final measurement. The device is baked at a low temperature to further set the device. This baking is typically in the range of 4-24 hours. A final measurement determines that the finished device meets the required specification.

Currently typical device manufacturing processes move the device from step to step using a tray or as a bare fiber. At each step of the process, the operator manually places the device in any required fixtures for the processing step. The tension of the fiber must also be set for various processing steps, and often this is done using a manual adjustment. During the various processing steps, a fiber breakage test can be done by placing a large tension of the fiber to determine if the fiber has been damaged during processing. The fiber is then removed from the processing fixture and returned to the tray. Also, some of the process steps may use multiple fixtures to complete the process step. This involves further manual handling of the fiber.

The device is measured at various points throughout the manufacturing process. This ensures that the device is within specification prior to performing the next processing step. Measuring the device involves the splicing of the device to the measurement system. The splicing operation involves manual handling of the fiber. Then the device must be cut from the measurement system. Alternatively, a measurement port may be attached to the ends of each fiber. The measurement ports are then plugged into a measuring device. This approach still requires significant fiber handling to perform measurements.

Currently the manufacture of optical fiber devices as described above involves significant manual labor and handling of the fiber. Repeated handling of the fiber causes the fiber to degrade and even to fail resulting in lower device yields and degraded performance. These problems are increased when a portion of the fiber is stripped as required for the manufacture of devices. In addition, many of the manufacturing steps involve manual operations by an operator. For example, devices are extremely sensitive to heat and tension, so if these parameters are not carefully controlled, performance and yield of the devices are reduced. Therefore, manual operations affecting these parameters introduce greater variability into the resulting devices. Again this results in lower device yields and degraded performance. The use of manual labor in the manufacture of devices also greatly increases the final cost of devices.

The manufacturing steps described above for processing FBGs may also be used in manufacturing other optical fiber devices. The steps may be identical or similar, but they also have the same problems as described with the manufacture of FBGs.

Therefore there remains a need to improve the manufacture of optical fiber devices. The present invention introduces automation into the optical fiber device manufacturing process to overcome the problems with present method of manufacture. The present invention reduces the variability of optical fiber device characteristics and cost while increasing yield and performance. These advantages and others will become apparent from the following detailed description.

### BRIEF SUMMARY OF THE INVENTION

The present invention is directed to methods, systems, and apparatuses for the automated manufacture of optical fiber devices. Work stations perform various steps in the manufacture of optical fiber devices. Fiber cassettes hold the optical fiber device and provide the vehicle for transporting the optical fiber devices from one work station to another. The fiber cassettes may also provide measurement ports to allow for measurement of the optical fiber device during processing. To provide for greater manufacturing efficiencies, the fiber cassettes can be ganged together in a magazine. The magazine allows for concurrent processing of the optical fiber devices contained in the magazine resulting in improved manufacturing throughput. In addition, each work station can be connected to a manufacturing control system. The manufacturing control system is a system that tracks each optical fiber device throughout the manufacturing process and that controls the manufacturing process. Fiber cassettes and magazines reduce touch times resulting in lower cost and improved yields and performance.

An embodiment of the present invention for the manufacture of optical fiber devices is described herein. Examples of work stations that strip and write a grating into a fiber and that anneal, recoat, package, and measure an optical fiber device are disclosed. These work stations may share a common design and may share various assemblies used to process the optical fiber device. The present invention may also be used to manufacture athermally packaged optical devices.

Another embodiment of the system for manufacturing optical fiber devices of the present invention includes a fiber magazine, a plurality of fiber cassettes within the magazine, the cassettes including alignment members and optical fiber in which the devices are to be formed, and a plurality of work stations including assemblies for processing the fiber in the cassettes, and including reciprocal alignment structures corresponding to the alignment members of the cassettes.

### BRIEF DESCRIPTION OF THE DRAWINGS

Embodiments of the present invention will now be described, by way of example only, with reference to the accompanying drawings for the purpose of illustrating embodiments only and not for purposes of limiting the same, wherein:

FIG. 1 shows an embodiment of a work station according to the present invention;

FIGS. 2 and 3 show an embodiment of a fiber cassette according the present invention;

FIG. 4 shows a more detailed view one embodiment of the fiber stabilizer according to the present invention;

FIG. 5 shows an exploded view of one embodiment of the cassette;

FIG. 6 shows a cross-sectional view of one embodiment of the fiber reel;

FIG. 7 shows a cross-sectional view of one embodiment of the fiber cage;

FIG. 8 shows a magazine for holding cassettes;

FIGS. 9 and 10 show one embodiment of a work station according to the present invention;

FIG. 11 shows one embodiment of a tension assembly which may be used in a work station;

FIG. 12 is a block diagram of one embodiment of a gripper assembly;

FIG. 13 is a block diagram of one embodiment of a system for manufacturing a device;

FIG. 14 shows one embodiment of a stripping assembly used by the stripping work station to strip the fiber;

FIG. 15 shows the three step process that the stripping assembly uses to strip the fiber;

FIG. 16 illustrates an annealing assembly found in an annealing work station;

FIG. 17 shows a cross-sectional view of one embodiment of a heater;

FIG. 18 shows an annealing block according to the present invention;

FIG. 19 shows the temperature regions in the annealing block around the FBG and adjacent optical fiber;

FIGS. 20 and 21 show a recoating assembly that may be used with the recoating work station to recoat fiber;

FIG. 22 shows a cross-sectional view of the recoating assembly illustrating a resin injector;

FIGS. 23 and 24 show cross-sectional views of one embodiment of the recoating assembly, with the upper molds, lower mold, and resin injector in the open and closed positions, respectively;

FIGS. 25 and 26 show a cross-section view of the open and closed molds through the continuity channels;

FIGS. 27 and 28 show the packaging fixture for use in a packaging work station for packaging devices;

FIG. 29 shows another view of the packaging fixture; and

FIG. 30 shows an adhesive assembly that may be used in a packaging work station.

### DESCRIPTION OF THE INVENTION

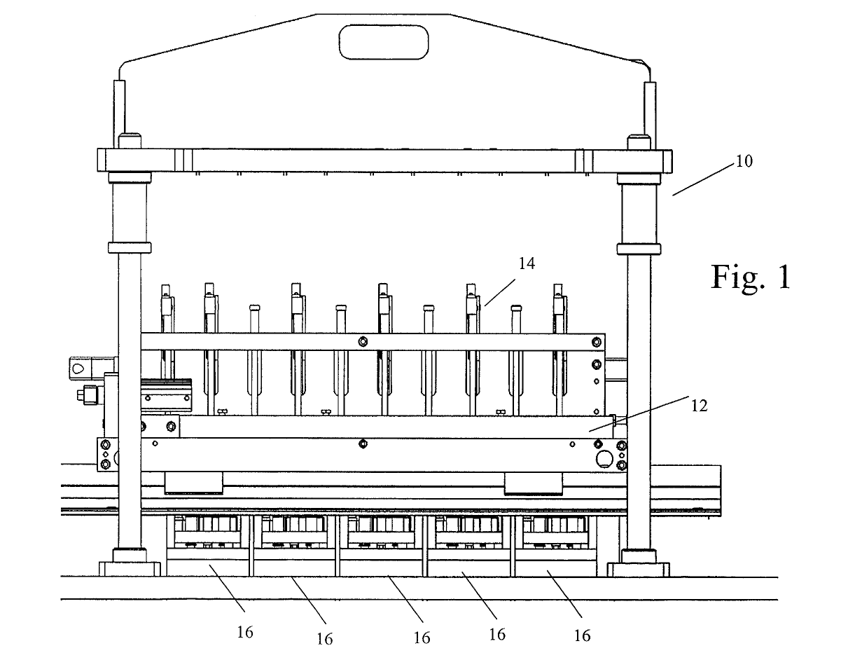

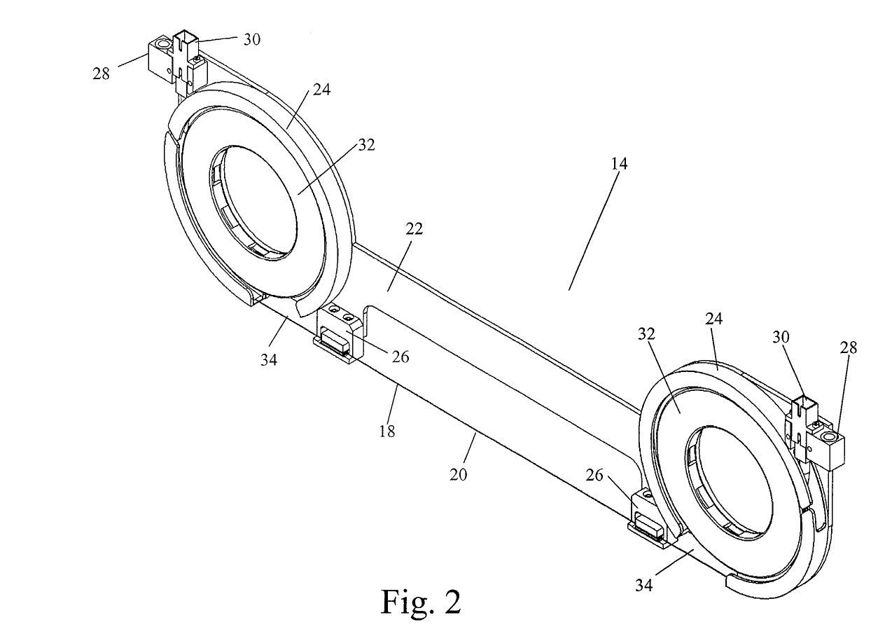

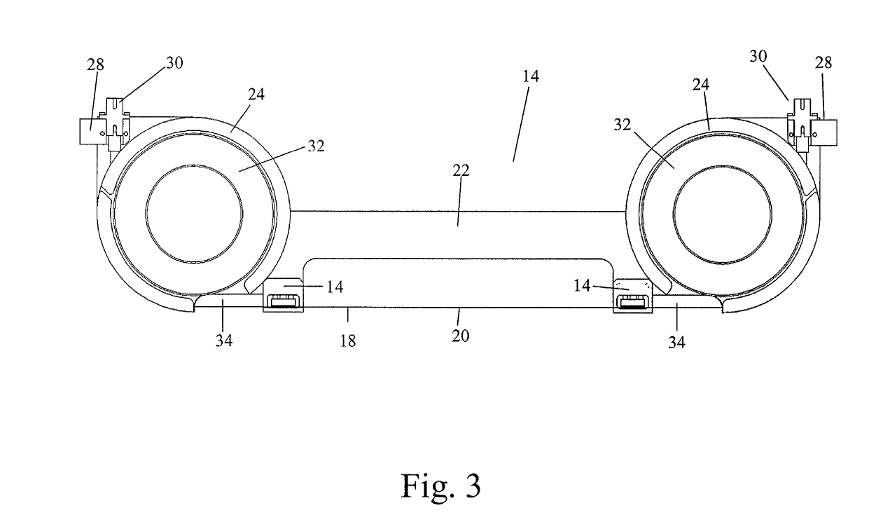

FIG. 1 shows an embodiment of a work station 10 according to the present invention. The work station processes optical fiber into optical fiber devices. The work station receives a magazine 12 that contains fiber cassettes 14. The cassettes 14 hold optical fiber 18 (see FIGS. 2 and 3) that is processed by the work station 10. The work station 10 has one or more assemblies 16 that engage and process the fiber 18. If the work station 10 has multiple assemblies 16, then multiple fibers 18 may be processed concurrently. Different work stations 10 employing different assemblies 16 may perform a variety of processing tasks. One or more work stations 10 may be used to manufacture an optical fiber device in the optical fiber 18. The work stations 10 may be built upon a common design, and many of the manufacturing steps performed at one work station 10 may be common to other work stations 10.

FIGS. 2 and 3 show an embodiment of a fiber cassette 14 according to the present invention. The cassette 14 can hold optical fiber 18, which may include or be processed to form an optical fiber device 20. The cassette 14 may include a connecting member 22, receptacles 24, fiber stabilizers 26, alignment members 28, measurement ports 30, and covers 32. The fiber cassette 14 holds the fiber 18 and provides the vehicle for processing the fiber and for transporting the fiber 18 to one or more work stations 10. After the fiber 18 is loaded into the cassette 14, the fiber may be processed without an operator handling the fiber 18, which reduces fiber weakening, fiber breakage, and device yield loss. The cassette 14 enables the fiber 18 to be consistently presented to work stations 10 for processing, which ensures the reliability of processing and measurements by reducing the variability in fiber location. Fiber cassettes 14 also reduce operator touch times, resulting in reduced device cost.

The receptacles 24 provide storage for excess fiber. For example, the length of fiber used to manufacture the device 20 is typically much longer than the device 20 itself, and the receptacles 24 provide storage for that excess fiber. The receptacles 24 shown are round, but other shapes may be used as well. Additionally, the receptacles 24 should be sized to account for the minimum bending radius of the fiber 18 in order to reduce stress placed on the fiber 18. Alternatively, one or no receptacles 24 may be utilized, such as in a cassette 14 in which excess fiber 18 requiring storage is present at only one side, or at neither side, of the device 20. For example, the receptacles 24 may be eliminated and the fiber 18 attached to the cassette 14 near the ends of the fiber 18.

The connecting member 22 connects the two receptacles 24. The length and location of the connecting member 22 affects the amount of fiber 18 exposed and the amount of space that the various work stations 10 have to process the device 20.

Stabilizers 26 hold the fiber 18 in place, thus preventing the movement of the device 20. The stabilizers 26 ensure that, as the cassette 14 moves from one work station 10 to another, the device 20 is located in the same position relative to the fiber cassette 19. Therefore, the work stations 10 do not need to have the capability to locate the device 20, thereby resulting in reduced cost and complexity of the work stations 10. Alternatively, the stabilizers 26 may be omitted if, for example, the receptacles 24 or other parts of the cassette 14 are capable of maintaining the location of the device 20 in the cassette 14, or if the work stations 10 are able to locate the device 20.

Alignment members 28 allow the cassette 14 to be properly aligned in a work station 10. The alignment member 28 may include an opening that is engaged by the work station 10 to align the cassette 14 within the work station 10. The alignment members 28 may be attached, for example, to the connector member 28 or the receptacle 24.

Measurement ports 30 facilitate the measurement of the characteristics of the fiber 18 and/or device 20. The measurement port 30 may be directly or indirectly attached to the fiber 18. When the cassette 14 is in a work station 10, the measurement port 30 can be engaged and used to measure the fiber 18 and/or device 20. In one embodiment, the measurement port 30 includes a fiber tail that connects to the fiber 18. After the measurement port is used, the fiber tail may be cut from the fiber 18, and the fiber tail then attaches to the next fiber 18 inserted into the cassette 14, without having to replace the measurement port 30 or reconnect the fiber 18 to the measurement port 30. An alternative to splicing the fiber 18 to the measurement port is to use a ferrule or other connector technique on the fiber 18 and the measurement port 30. The measurement ports 30 provide an advantage over prior art manufacturing processes where the fiber 18 had to be spliced each time it was measured. The measurement ports 30 allow the work station 10 to measure the device 20 as often as needed and in real time while the device 20 is being processed without requiring additional handling and splicing of the fiber 18.

The stabilizer 26, connecting member 22, and receptacle 24 may be arranged so that there is a gap 34 (FIGS. 2 and 3) between the fiber 18 and the cassette 14. This gap 34 allows the work station 10 to engage the fiber 18, such as to retension of the fiber 18.

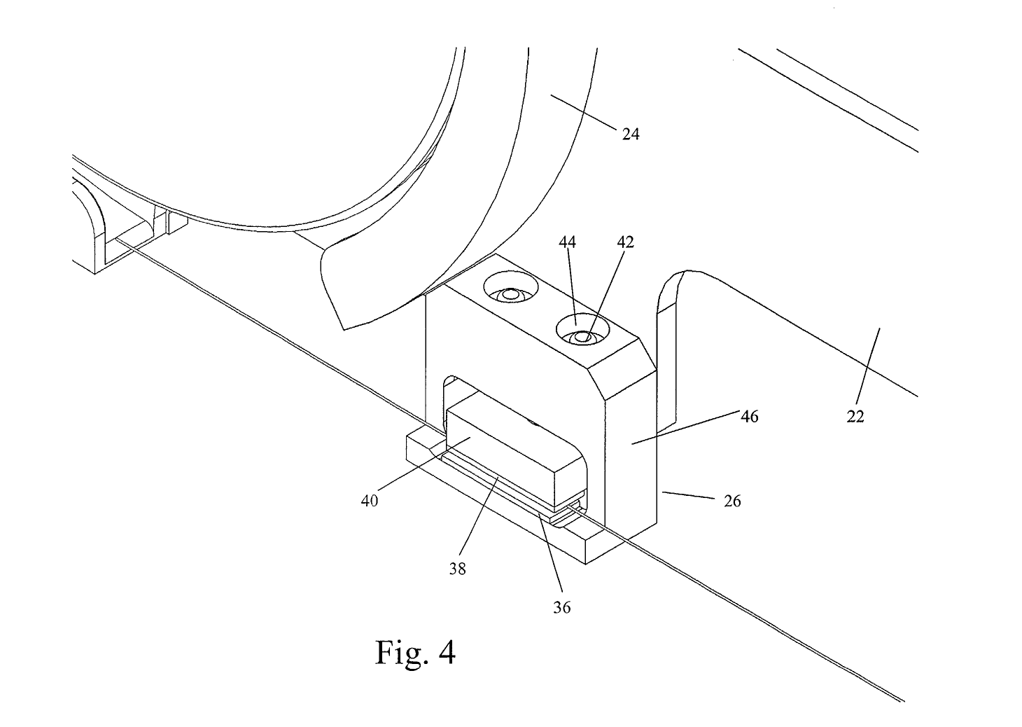

FIG. 4 shows a more detailed view of one embodiment of the stabilizer 26. The stabilizer 26 includes lower and upper grippers 36, 38 that grip the fiber 18. The upper gripper 34 connects to a slide 40 that moves up and down on rods 42 passing through openings 44 in the frame 46, to disengage and engage, the fiber 18. A spring may be used to bias the upper gripper 34 in a desired position, such as to bias the upper and lower grippers 36, 38 into engagement, unless a sufficient counterforce is applied. The upper gripper 34 may be arranged so that it may be pushed away from the lower gripper 36 by the work station 10, such as to allow the work station 10 to adjust tension on the fiber 18. In one embodiment, the grippers 36, 38 are made of a compressible material such as rubber that will grip the fiber 18 and hold it in place without damaging it. Other suitable materials may be used as well.

The stabilizers 26 may take other forms as well. For example, the stabilizer 26 may clamp the grippers 36, 38 together using a locking mechanism. The stabilizer 26 may also have a quick release mechanism to allow for easy release of the fiber 18. Also, the stabilizers 26 may be releasable by the work stations 10.

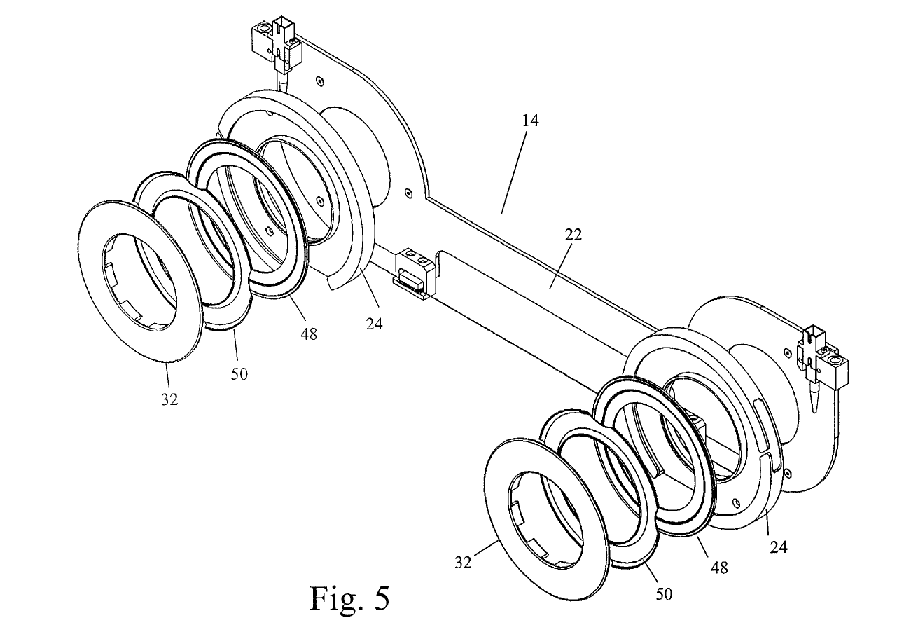

FIG. 5 shows an exploded view of one embodiment of the cassette 14. A fiber reel 48 within the receptacle 24 may hold the fiber tail from the measurement port 30. A fiber cage 50 may hold the excess fiber 18 in which the device 20 is formed. A cover 32 retains the fiber reel 48 and fiber cage 50 within the receptacle 24. It is also possible to place the fiber 18 within the receptacle 24 without a fiber reel 48 or fiber cage 50. The tendency of the fiber 18 to uncoil within the receptacle 24 will often allow the fiber 18 to remain securely within the receptacle 24. FIG. 5 also shows how the receptacles 24 attach to the connecting member 22. It is not necessary for the connecting member 22 to extend completely behind the receptacles 24, but the connecting member 22 may attach only to one edge of each receptacle 24.

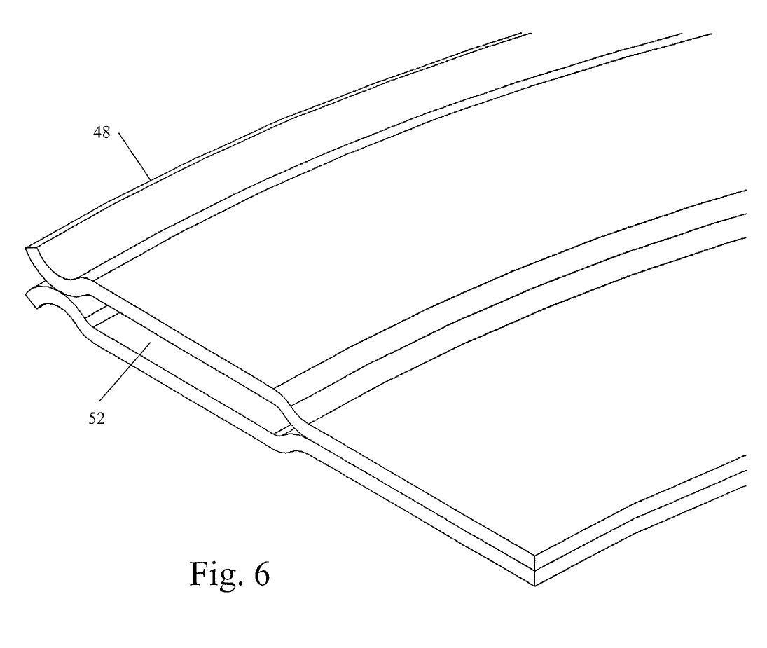

FIG. 6 shows a cross-sectional view of one embodiment of the fiber reel 48. The fiber reel 48 includes an opening 52 in which fiber is contained. The opening 52 may be located so as to maintain the minimum bend radius for the fiber. The fiber reel 48 provides storage of fiber, reduces tangling of the fiber, and allows fiber to be removed from the reel as needed. For example, the fiber tail from the measurement port 30 may be stored by winding it onto the fiber reel 48. Typically, as the size of the reel opening 52 in the fiber reel 48 is reduced, the likelihood that the fiber will tangle is reduced.

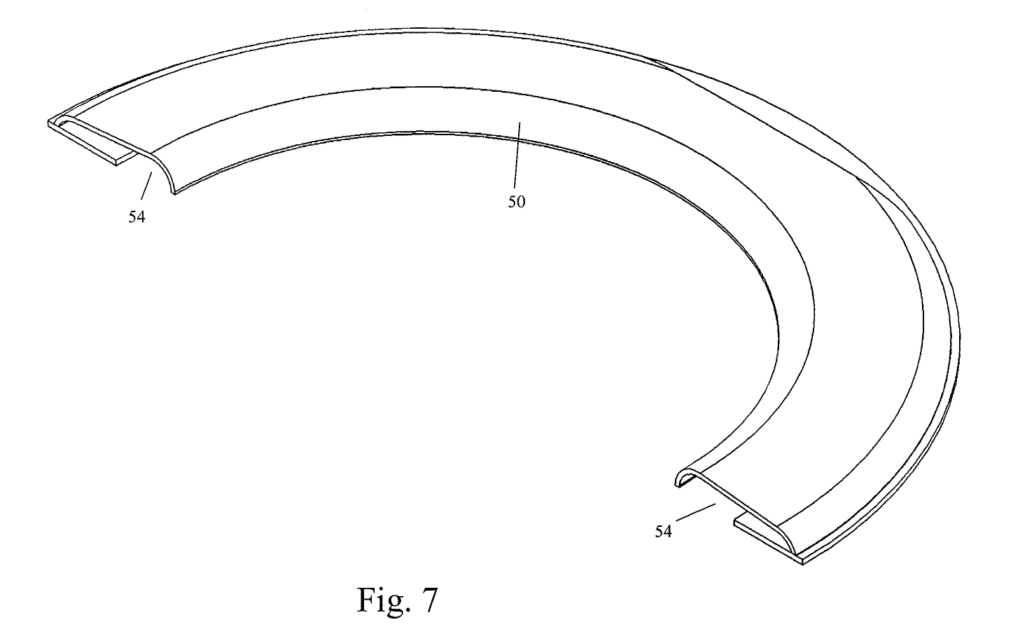

FIG. 7 shows a cross-sectional view of one embodiment of the fiber cage 50. The fiber 18 is wound into the cage through the cage opening 54. The tendency of the fiber 18 to uncoil will allow the fiber 18 to remain securely within the fiber cage 50. The fiber cage 50 allows for a portion of fiber 18 to be withdrawn from the fiber cage 50 by gripping the fiber 18 and pulling it out. This may be desirable for work stations 10 having space limitations that prevent the processing of the device 20 within the cassette 14. Upon completion, the work station 10 can feed fiber 18 back into the fiber cage 50. In addition, the fiber cage allows for easy loading and unloading of fiber 18, which may be useful during the processing of the fiber 18. The fiber cage 42 may be used, for example, to store excess fiber 18 that is being processed. The fiber 18 may be wound into the fiber cage 50 prior to processing and then easily removed from the fiber cage 50 after the processing is completed.

The present invention provides for many variations in fiber storage. For example, a cassette 14 may use neither a fiber reel 48 nor a fiber cage 50, a cassette 14 may use only a fiber reel 48, a cassette 14 may use only a fiber cage 50, or a cassette 14 may use both a fiber reel 48 and fiber cage 50.

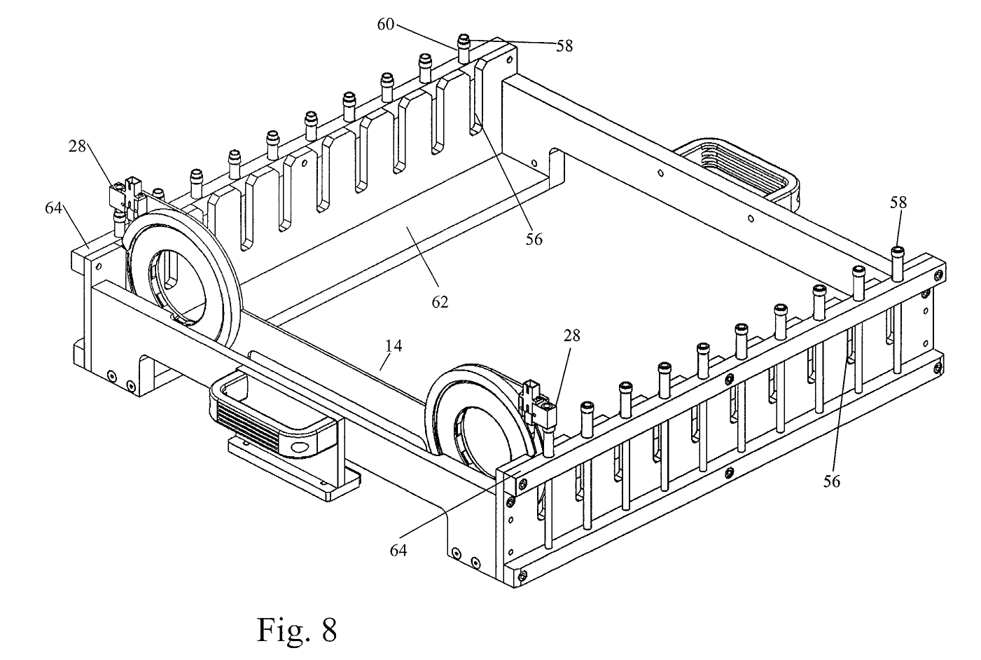

FIG. 8 shows a magazine 12 for holding cassettes 14. The magazine 12 may hold several cassettes 14 to provide for greater manufacturing efficiencies. The magazine 12 provides an efficient vehicle for transporting and processing cassettes 14. A magazine 12 holding several cassettes 14 maybe inserted into a work station 10, or into several work stations 10 in succession, thereby making several cassettes available to a work station 10 without the need for human or other intervention to insert or remove additional cassettes. The magazine 12 allows for sequential or concurrent processing of the devices 20 contained in the cassettes 14, resulting in improved manufacturing throughput. The magazine 12 enables the cassettes 14 to be consistently presented to work stations 10 for processing, which ensures the reliability of processing and measurements by reducing the variability in fiber location. The magazine 12 includes slots 56 into which cassettes 14 are received and supports 58 on which the cassettes 14 rest. The supports 58 may slide up and down within the magazine 12 and may be biased, such as with a spring 60, to keep the support 58 in a desired position.

In one embodiment, the supports 58 are biased in a raised position to provide appropriate clearance between the cassette 14 and assemblies 16 in the work station 10. The cassettes 14 are subsequently lowered by the work station 10 for processing. When a work station 10 receives a magazine 12, the work station 10 engages the alignment members 28 and pushes the cassette 14 towards the magazine 12 until the cassette 14 comes into contact with the base 62 or something else that limits the motion in the magazine 12. In another embodiment, the support 58 can have a stop that limits the movement of the cassette 14 in the magazine 12. When the supports 58 are in their highest position, the device 20 is recessed from the bottom of the magazine 12, where it is less likely to be damaged. In another embodiment of the magazine 12, the supports 58 are not present, and the cassettes 14 rest on a ledge 64 or some other support.

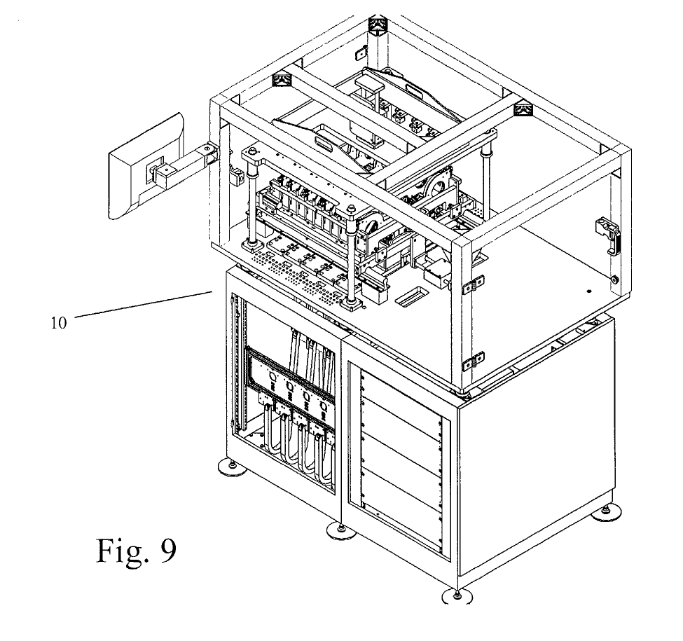

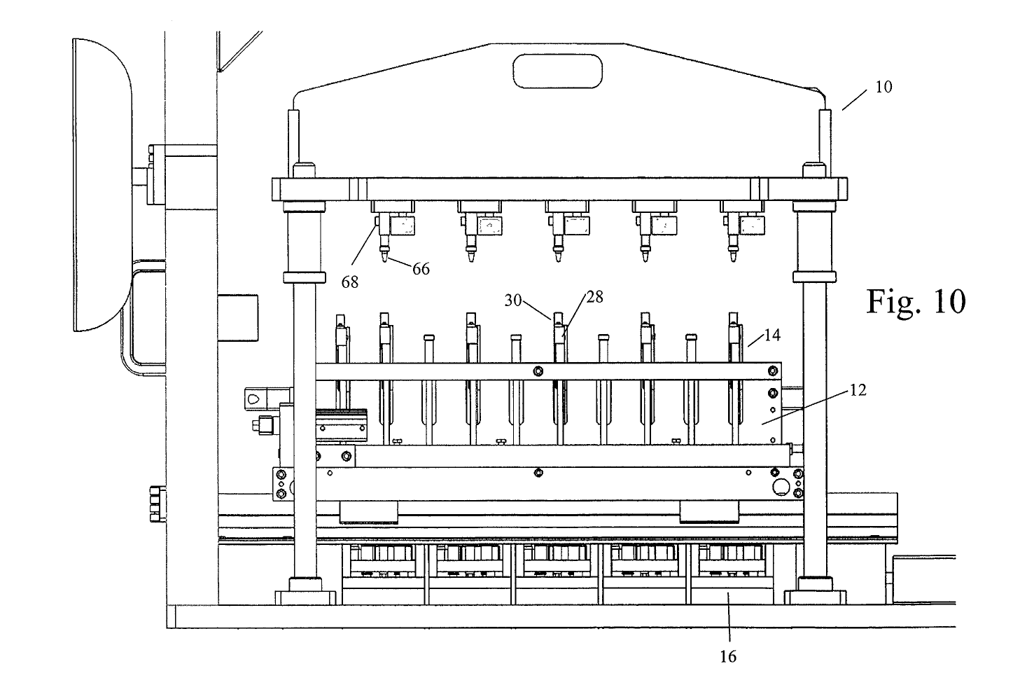

FIGS. 9 and 10 show one embodiment of a work station 10 according to the present invention. The work station 10 is shown with a magazine 12 loaded with several cassettes 14. The work station 10 may have a alignment member 66 that engages the alignment member 28 to align the cassette 14. For example, the work station 10 may have an alignment member 66 that includes pins for use with alignment members 28 in the cassettes 14 that have corresponding openings. The work station 10 may also have an alignment member 66 that is a slot that receives a corresponding alignment member 28 and aligns the cassette 14.

The pins and slots in the alignment members 66 can be tapered to facilitate engagement with corresponding openings in alignment member 28 and to allow for variations in the position of the cassette 14 relative to the work station 10. The pins may be lowered or raised to engage the opening and to align the cassette 14 into a known position. In one embodiment, when the reciprocal alignment members 66 of the work station 10 engage the cassette 14, the work station 10 pushes the cassette 14 down, and compresses the supports 58, thereby bringing the devices 20 closer to the assemblies 16 where it may be more convenient to operate on the device 20.

The work station 10 may have measurement ports 68 that connect with the measurement ports 30 on the cassette 14 to measure characteristics of the fiber 18 or device before, during, or after processing. For example, the work station 10 may measure the reflection and/or transmission wavelengths during the manufacture of devices 20, such as FBGs. In that example, the work station 10 may include a heater or other temperature controller to set the device 20 temperature to a known value for the measurement.

The work station 16 may include one or more assemblies 16 for processing the fiber 18. The assemblies 16 may all be of the same or different types. The assemblies 16 may move to engage the fibers 18, or the fibers may be moved so that the assemblies 16 may engage the fibers 18. If the number of assemblies 16 is less than the total number of cassettes 14 in the magazine 12, then the assemblies process a first group of fibers 18, and then the next group, until all of the fibers 18 have been processed. The assemblies may be arranged to process fibers 18 in adjacent cassettes 14 or fibers 18 in nonadjacent cassettes 14. Also, the work station 16 may move assemblies 16 or the magazine 12 to allow the assemblies 16 to process different groups of fibers 18.

Some work stations 10 may control the tension on the fiber 18. For example, some work stations 10 may perform fiber pull tests to detect cracks or other flaws in the fiber 18. A fiber pull test places the fiber 18 under a tension, which may be, for example, based upon the maximum tension expected during handling, installation, and operation of the device 20. If the pull test breaks the fiber 18, the fiber 18 is discarded; otherwise, the fiber 18 continues to be processed. Tension may also be controlled to set the fiber tension for measurement, packaging, or other processing steps.

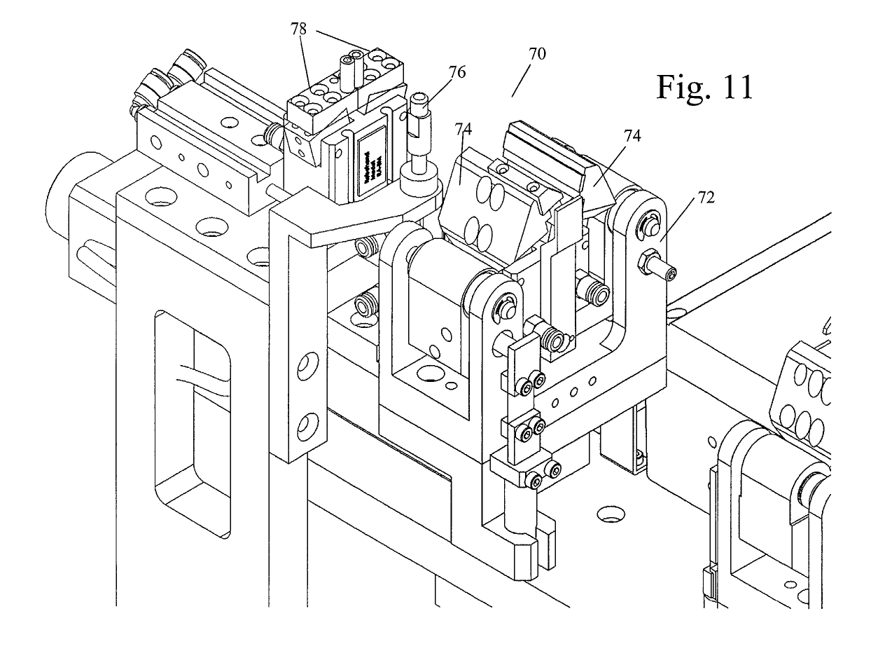

FIG. 11 shows one embodiment of a tension assembly 70 which may be used in a work station 10 for placing tension on the fiber 18. The tension assembly 70 has a gripper assembly 72 with grippers 74 that close to grip the fiber 18 (not shown). The tension assembly 70 may raise a release rod 76 to lift and release the upper gripper 34 in the cassette 14. Next, the tension assembly 70 places tension on the fiber 18 using gripper assembly 72. The gripper assembly 72 may be attached to a motor that moves the gripper assembly 72 to adjust the tension on the fiber 18. Various types of motors may be used depending upon how fine the tension control must be. The fiber 18 is anchored to provide resistance to the pulling of the gripper assembly 72. Anchors may include a stabilizer 26 or another gripper assembly 72. Once the work station 10 completes processing the fiber 18, the tension assembly 70 has retensioners 78 that grip the fiber 18. The grippers 74 release the fiber 18, and the retensioners 78 place appropriate tension on the fiber 18. The tension assembly 70 lowers the release rod 76 allowing the upper gripper 34 in the cassette 14 to hold the fiber 18 in place under the tension provided by the retensioners 78. The retensioners 78 then release the fiber 18. It is also possible for the retensioners 78 to grip and tension the fiber 18 prior to the grippers 74 releasing the fiber 18.

The tension assembly 70 keeps the device 20 in the same location during and after the work station 10 processing. The tension assembly 70 may lower the gripper assembly 72 after gripping the fiber 18 to provide space for other assemblies in the work station 10 to process the fiber 18. In this case, the tension assembly 70 may include a second gripper assembly 72, so that the fiber 18 may be gripped in two locations and lowered.

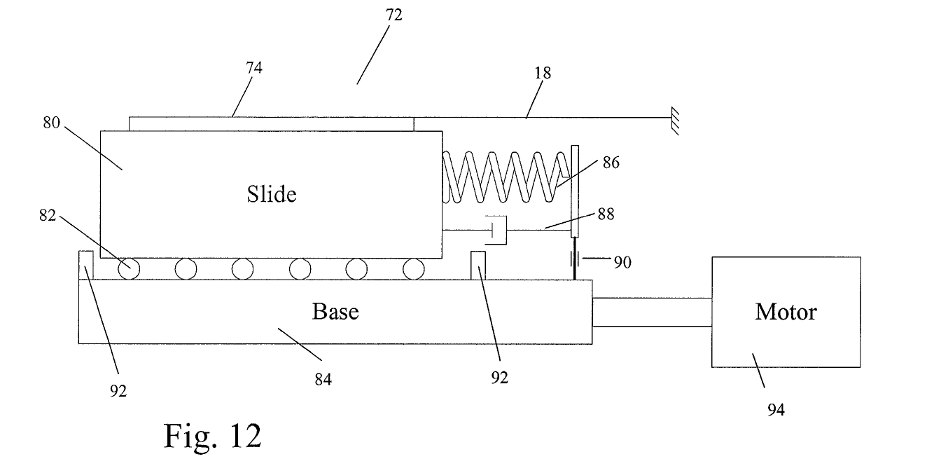

FIG. 12 is a block diagram of one embodiment of a gripper assembly 72 that may be used to set the tension on the fiber 18 to zero. Grippers 74 are mounted on a slide 80 that may, for example, ride on a friction free air bearing 82 or other type of bearing. A base 84 connects to the slide 80 via a spring 86 and dash pot 88 that control the motion of the slide 80. The spring 86 compresses and exerts a force on the slide when it moves towards the spring 86. The dash pot 88 dampens sudden motions of the slide to smooth out quick movements of the base 84. The gripper assembly 72 has a strain gauge 90 connected between the base 84 and slide 80 to measure strain, which is indicative of strain in the fiber 18. The gripper assembly 72 has stops 92 to limit the strain range of the system. A motor 94 or other suitable device drives the base 84. The gripper assembly 72 controls the motor 94 driving the base 84 via feedback control. The strain gauge 90 produces a signal indicating the strain on the fiber 18 that is then compared to a desired strain setting resulting in an error signal. The error signal drives the motor 94 to compensate for the error.

The work stations 10 may also be designed to allow for automatic loading and unloading of the magazine 12 from the work station 10. The magazine 12 may then be conveyed automatically from one work station 10 to another using a conveyer system and then loaded and unloaded into the work stations 10. This allows for a completely automatic manufacturing process.

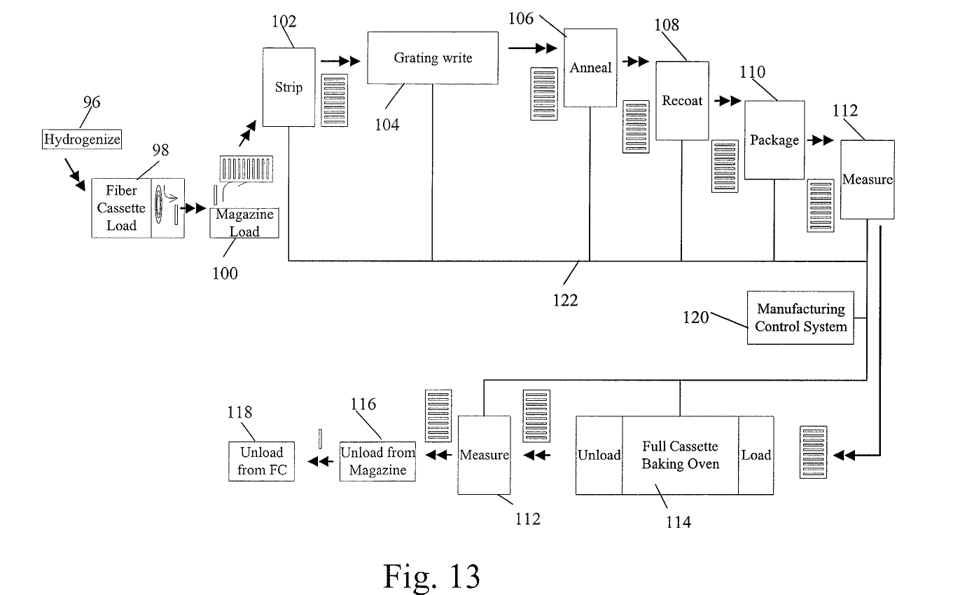

FIG. 13 is a block diagram of one embodiment of a system for manufacturing a device 20, such as a FBG. The system includes several work stations 10 to process optical fiber 18. The system may include more or less work stations 10 than those illustrated, and the work stations 10 may perform the same or different functions. The number, type, and arrangement of work stations 10 will vary depending on the type of device 20 being produced. In the illustrated embodiment, the system includes a hydrogenation work station 96, a fiber cassette loading work station 98, a magazine loading work station 100, a stripping work station 102, a grating write work station 104, an annealing work station 106, a recoating work station 108, a packaging work station 110, a measurement work station 112, a baking work station 114, a magazine unloading work station 116, and a cassette unloading work station 118. The system in the illustrated embodiment also includes a manufacturing control system 120 connected to the work stations via a network 122 to monitor and control the work stations. Each work station includes processing assemblies which perform the particular processing steps of the work stations. The structure and operation of the work station 10 are described below.

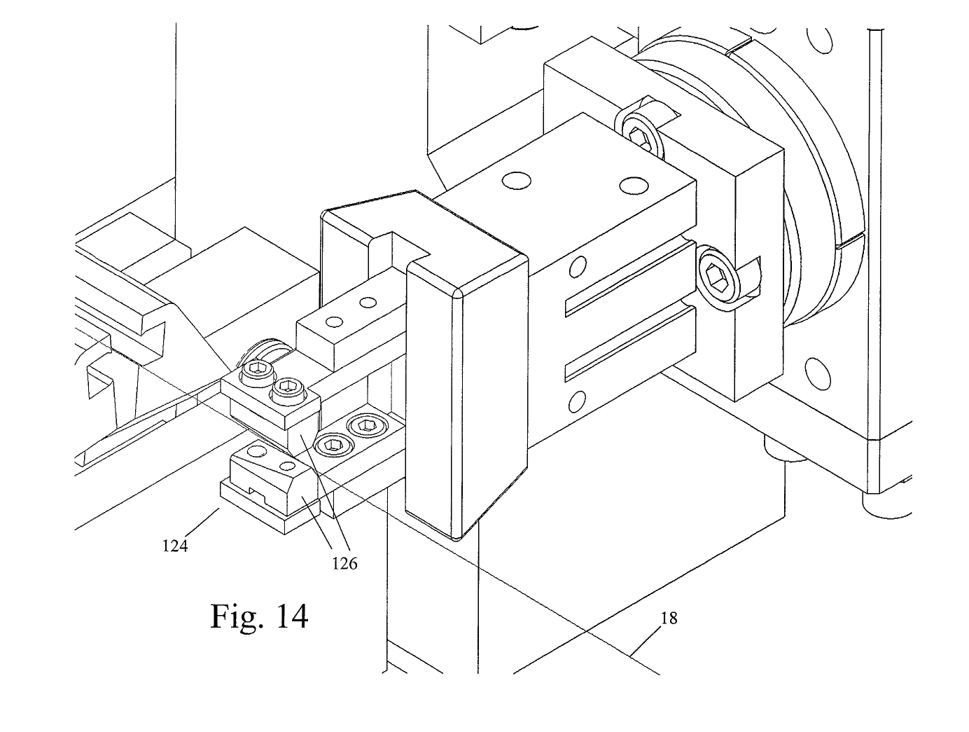

A stripping work station 102 strips the coating from the fiber 18 as required to manufacture certain types of devices 20, such as FBGs. The stripping work station 102 strips each of the fibers 18 in the magazine 12. The stripping work station 102 has stripping assemblies 124 (see FIG. 14) to strip the fibers 18. Also, the stripping work station 102 may employ a tension assembly 70 to place tension on the fiber 18 to facilitate stripping. Alternatively, the stabilizers 26 may be used to maintain sufficient tension on the fiber 18 during stripping. The stripping work station 102 may have only one stripping assembly 124 for processing one cassette 14 in the magazine 12 at a time. The stripping work station 102 may also have multiple stripping assemblies 124, and if the number of stripping assemblies 124 is the same as the number of cassettes 14 in the magazine 12, the fibers 18 can all be stripped at the same time. Otherwise, the stripping work station 102 may use multiple stripping assemblies 124 to strip multiple fibers 18 and then continues to the remaining fibers 18 until all the fibers 18 have been stripped. The stripping work station 102 may identically control the multiple stripping assemblies 124, that is, each stripping assembly 124 strips the same length and location of fiber 18 in each cassette 14. Alternatively, the stripping work station 102 may control each stripping assembly 124 independently to allow each assembly to strip each fiber 18 differently.

FIG. 14 shows one embodiment of the stripping assembly 124 used by the stripping work station 102 to strip the fiber 18. The stripping assembly 124 uses two blades 126 to strip the fiber 18. The stripping assembly 124 may use plastic blades because they decrease the potential damage to the fiber 18 during stripping, or blades made of other materials my be used as well.

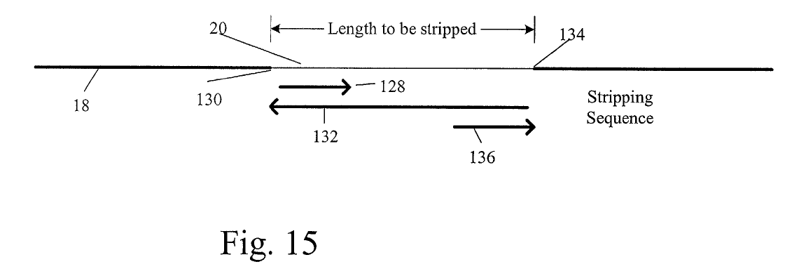

FIG. 15 shows a three step process that the stripping assembly 124 may use to strip the fiber 18. First, the stripping assembly 124 closes the blades 126 on the fiber 18 and moves the blades 126 along the path 128. In the first step 128, the stripping assembly 124 starts the blades 126 near the first edge 130. During the first stripping step 128 the stripping assembly only traverses part of the length of fiber 18 to be stripped. The stripping assembly 124 then releases the blades 126 and rotates them 1800.

In the second step 132, the stripping assembly 124 moves the stripping assembly 124 to position the blades 126 near the second edge 134. The stripping assembly 124 closes the blades 126 to engage the fiber 18 and moves toward the first edge 130 along the fiber 18. Again, the blades 126 do not begin stripping at the second edge 134. The stripping assembly 124 continues the second step 132 until the blades 126 reach the desired location of the first edge 130. The second step 132 leaves the fiber 18 cleanly stripped to the first edge 130.

In the third step 136, the stripping assembly 124 rotates the blades 126 180° and strips the fiber 18 back towards the second edge 134 leaving the fiber 18 cleanly stripped to the second edge 134. Alternatively, the stripping assembly 124 may strip the fiber 18 using only one or two stripping steps resulting in a first edge 130 and a second edge 134 that are not as clean as in the three step process.

Returning to FIG. 13, the writing work station 104 writes the device 20 by using the interference pattern from two different ultraviolet light sources to change the structure of the fiber 18. The writing work station 104 may have a gripper assembly 72 to set the tension of the fiber 18 because the tension on the fiber 18 during writing affects the characteristics of the resulting device 20.

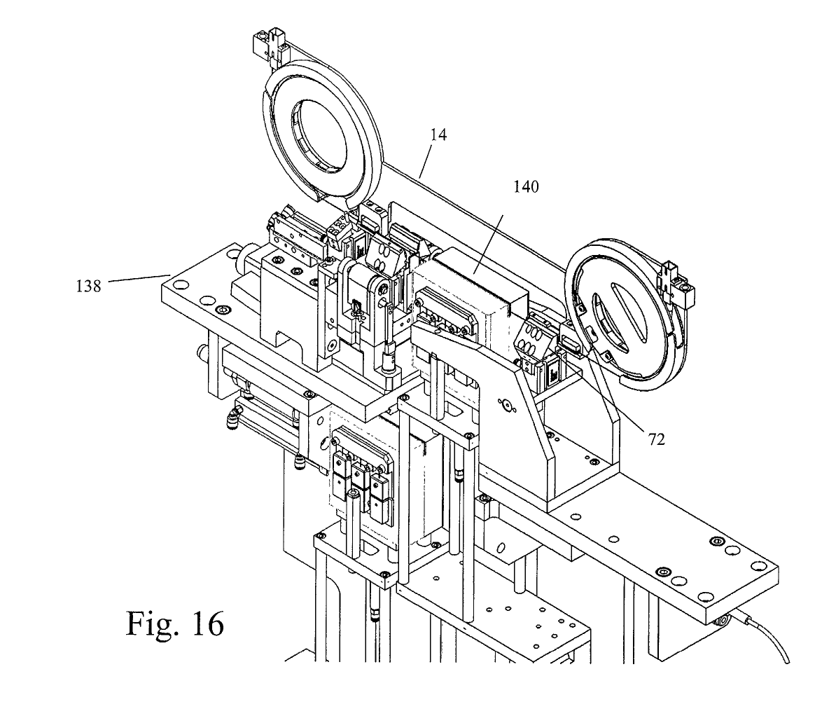

The annealing work station 106 anneals the device 20. Annealing involves heating the device 20 to high temperature, such as to stabilize the device 20. Annealing is also known as accelerated aging. After a device 20 is annealed it may be measured, and if the device 20 is not within specification it can be further heated to bring the device 20 performance back into specification. This additional heating is known as trimming. The annealing work station 106 includes an annealing assembly 138 (see FIG. 16) to anneal the device 20. The annealing work station may also include a tension assembly 70. To measure the device 20, the annealing work station 106 may have a heater and measurement ports 68. The annealing work station 106 may have one or multiple annealing assemblies 138 for annealing devices 20. If the annealing work station 106 has multiple annealing assemblies 138, the annealing work station 106 operates the annealing assemblies 138 concurrently in order to increase the throughput of the annealing work station 106. Each annealing assembly 138 may be independently controlled because each device 20 may have different annealing and trimming requirements.

FIG. 16 illustrates an annealing assembly 138 found in an annealing work station 106. The annealing assembly 138 includes an annealing block 140 that anneals the device 20. The annealing assembly 138 may also include a heater to heat the device 20 during measurement.

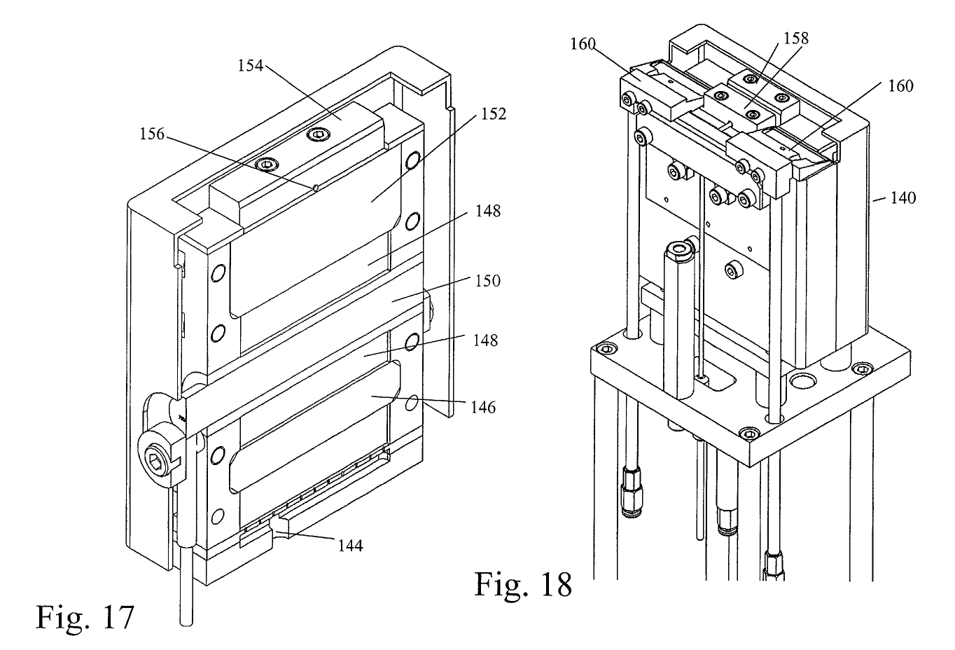

FIG. 17 shows a cross-sectional view of one embodiment of a heater 142. The heater 142 may heat the device 20 directly or indirectly. For example, the heater 142 may heat a gas and then use the heated gas to heat the device 20. That approach is advantageous because it allows more control over contaminants and impurities to which the device 20 is exposed. Nitrogen gas is particularly suitable because of its stability and low cost. In one embodiment, nitrogen gas enters the heater 142 at an inlet 144 near the bottom of the heater 142. The nitrogen diffuses through a lower porous ceramic block 146 into a cavity 148 with a heater element 150. The nitrogen flows through the cavity 148 and passes around the heater element 150. The heater element 150 heats the nitrogen. The heated nitrogen then passes from the cavity 148 through an upper porous ceramic block 152 that reduces temperature gradients in the heated nitrogen. As the heated nitrogen diffuses out of the upper porous ceramic block 152, it surrounds and heats the fiber 18 (not shown) situated between the heater heads 154. The heater 142 may have thermo-couplers 156 that provide feedback to control the heater element 150. Gases other than nitrogen may also be used with the heater 142. Also, the ceramic blocks 146, 152 may be made of other materials that are porous and capable of withstanding the temperatures pr

FIG. 18 shows an annealing block 140 according to the present invention. The annealing block 140 is similar to the heater 142. However, the annealing block 140 may use a different heater element 150 to produce higher temperatures than required by the heater 90. The annealing block 140 may also use different annealing heads 158. The annealing heads 158 may vary in length or otherwise because it is sometimes desirable for the annealing heads 158 to be approximately the same length as the device 20 being annealed.

The annealing block 140 may also include jets 160 to cool portions of the fiber 18 that are not to be annealed. Cooling of the fiber 18 can be important because the annealing process often exceeds 150° C. and can degrade the coating of the fiber 18 and cause other damage to fiber 18. In the illustrated embodiment, jets 160 on each side of the annealing heads 158 blow a curtain of air 164 on and/or under the fiber 18 adjacent to the device 20 to protect the adjacent fiber 18 from the heat of annealing. It has been found that an effective way to cool the fiber 18 is to direct air under the fiber 18 in order to keep the hot air rising from the annealing block 140 away from the fiber 18. The jets 160 may also cool the fiber 18 by directing air at the fiber 18 itself. The jets 160 may utilize nitrogen or other gases for cooling. Nitrogen is advantageous because of its stability and low cost, although other gases may also be used. The annealing block 140 may include interchangeable parts, such as the annealing heads 158 and jets 160, which may be frequently changed to accommodate different devices 20.

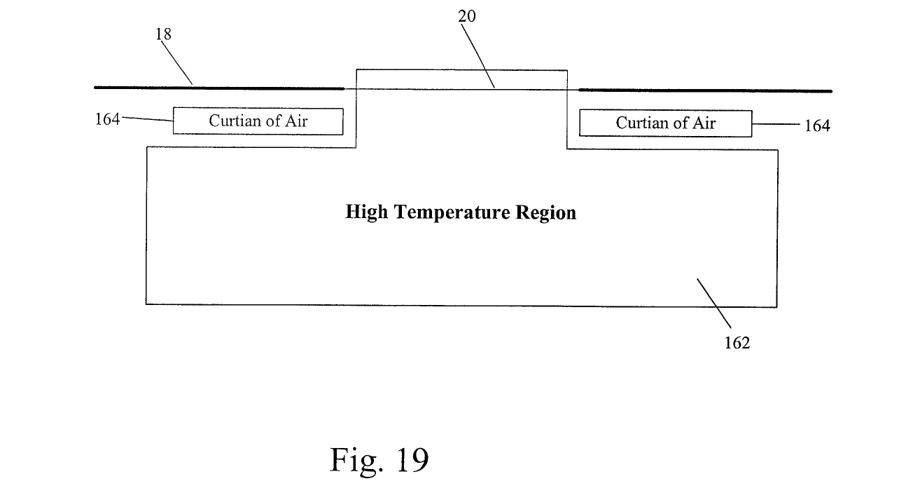

FIG. 19 shows the temperature regions in the annealing block 140 around the device 20 and adjacent optical fiber 18. A high temperature region 162 results from the flow of heated nitrogen and envelops the device 20. The curtain of air 164 prevents the heated air from enveloping the coated portions of the optical fiber 18, and thus limits the extent of the high temperature region 162.

The annealing work station 106 may use the following steps to anneal the device 20. The annealing work station 106 accepts a magazine 12 containing cassettes 14. The annealing work station 106 may first measure the device 20 prior to annealing, such as with a measurement heater 142, gripping assembly 68, and measurement ports 68 as previously described. If annealing work station 106 determines that the device 20 fails to meet the specification, the device 20 is failed and no further processing is done. If the device 20 meets the specification, the annealing work station 106 anneals the device 20 using an annealing block 140. The annealing block 140 heats the device 20 to a specified temperature for a specific time. Typical annealing temperatures may be 250-400° C., and typical annealing times may be 5-15 minutes. The annealing work station 106 selects the time and temperature parameters based upon the type of fiber 18 used to manufacture the device 20 and the characteristics of the device 20 itself. Also, the annealing work station 106 may use a varying heat profile during annealing. For example, the annealing work station 106 may anneal the device 20 for 5 minutes at 300° C., then 5 minutes at 350° C., and finally 5 minutes at 400° C. If the annealing work station 106 measures the device 20 prior to annealing, the annealing work station 106 may adjust the annealing parameters based upon the measured characteristics of the device 20.

After the annealing, the annealing work station 106 may measure the device 20 characteristics, and if the device 20 is within specification, then the processing is complete, otherwise the device 20 may be trimmed. Trimming or heating and then cooling the device 20 can cause the reflection wavelength of a FBG or other devices 20 to shift downward. Therefore, if the measured wavelength is greater than the specified wavelength, the annealing work station 106 can tune the device 20 by trimming the device 20. If the measured wavelength is less than the specified wavelength, then the device 20 is rejected, or the annealing work station 106 may further trim the device 20, resulting in a device 20 meeting the specifications for a device 20 with a different reflection wavelength. After trimming, the annealing work station may measure the device 20 again. If the device 20 is within specification, the processing is complete; otherwise, the annealing work station 106 may perform additional trimming iterations until either the device 20 meets specification or until the annealing work station 106 completes a certain number of iterations.

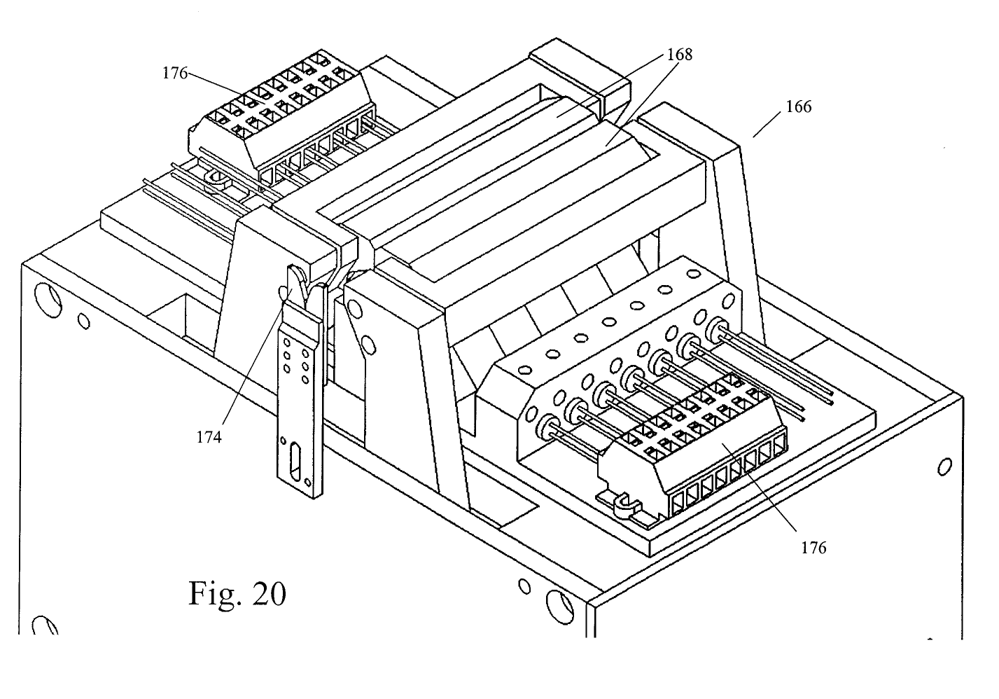

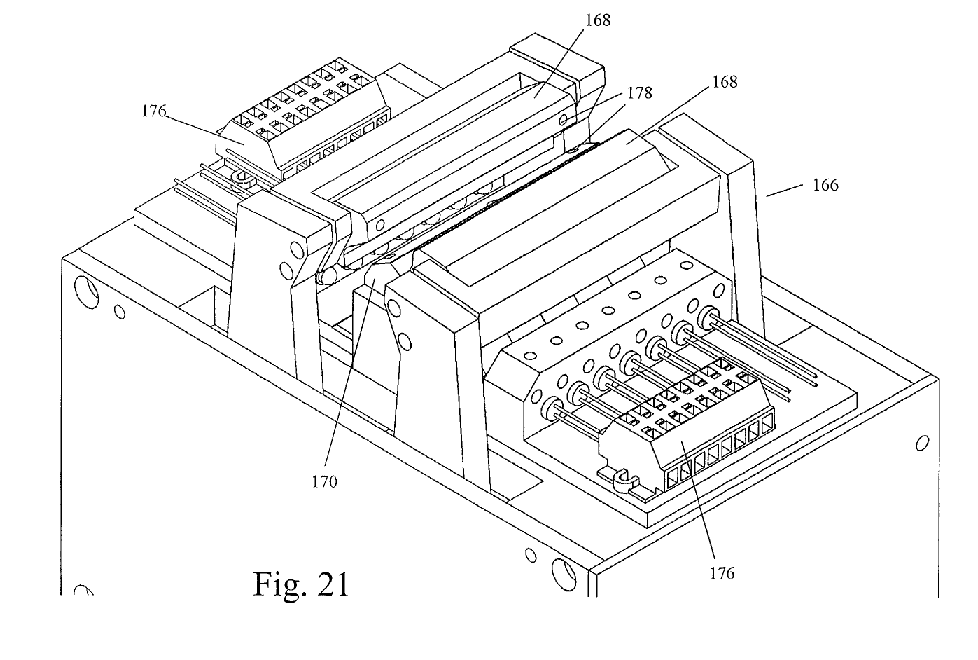

The recoating work station 108 recoats the device 20 after the annealing work station 106 anneals the device 20. The recoating work station 108 places the device 20 in a mold and injects resin into the mold. The recoating work station 108 cures the resin. The recoating work station uses a recoating assembly 196 (see FIGS. 20 and 21) to recoat the device 20. Also, the recoating work station 108 may have one or multiple recoating assemblies 166. Multiple assemblies will allow for increased throughput by taking advantage of multiple cassettes 14 grouped in the magazine 12. In addition, the recoating work station 108 may include a tension assembly 70 and may measure the device 20.

FIGS. 20 and 21 show a recoating assembly 196 that may be used with the recoating work station 108 to recoat fiber 18. FIG. 20 shows the recoating assembly 196 in the “closed” position, as it would be when recoating fiber 18. FIG. 21 shows the recoating assembly in the “open” position, as it would be when fiber was to be added or removed from the assembly. The recoating assembly 196 has upper molds 168 and a lower mold 170 which come together to form a mold cavity 172 (shown in FIG. 24) in which the recoating of fiber 18 occurs. The molds 168, 170 may be made of quartz, which is readily available, inexpensive, and easily machined. Other materials may be used as well, as long as they allow curing energy to reach the mold cavity 172 (see FIG. 24). Also, the recoating assembly 196 may have a fiber guide 174 to guide the fiber 18 (not shown) into the mold cavity for recoating. The recoating assembly 196 may also have energy sources 176 that produce energy that is coupled into the mold cavity to cure the recoating resin. The energy sources may be, for example, optical, RF, or thermal sources. The molds 168, 170 may include continuity channels 178 for checking that the mold cavity 172 has been properly formed.

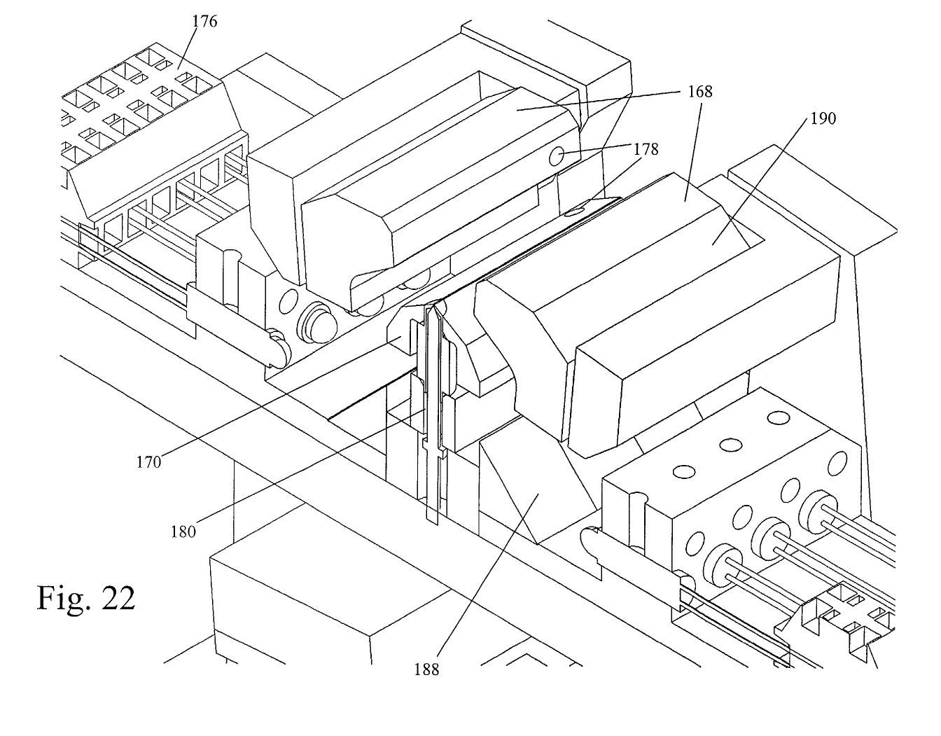

FIG. 22 shows a cross-sectional view of the recoating assembly 196 illustrating a resin injector 180 that opens into the mold cavity 172 and provides a coating resin that is used to recoat the fiber 18. The resin injector 180 is shown as being integral with the lower mold 170, although it may also be integrated into other molds or it may be oriented between molds 168, 170.

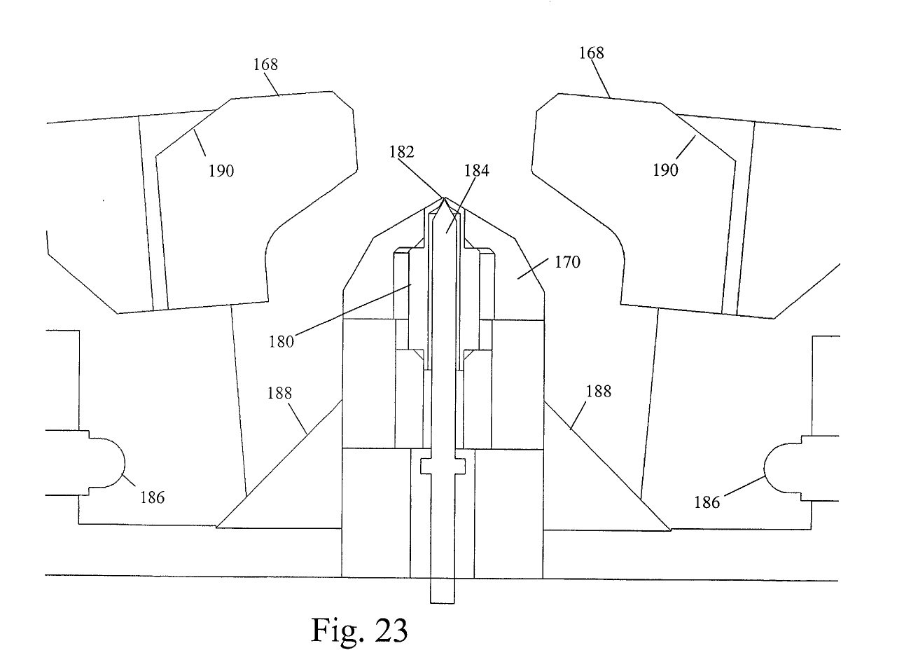

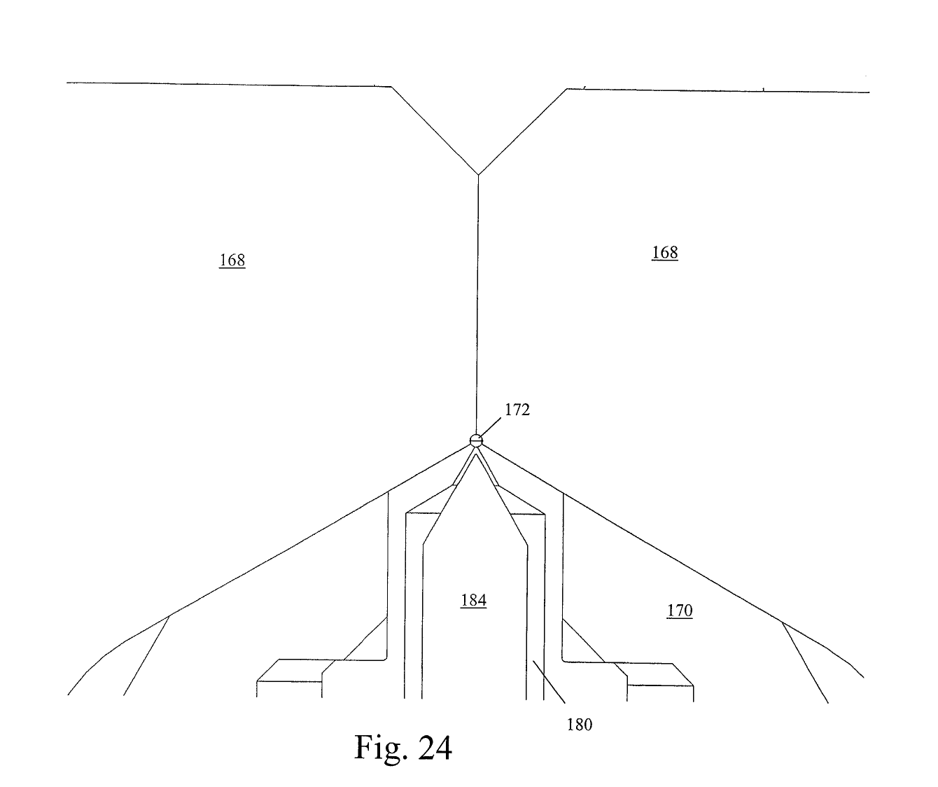

FIGS. 23 and 24 show cross-sectional views of one embodiment of the recoating assembly 196, with the upper molds 168 and lower mold 170 in the open and closed positions, respectively. The recoating assembly 196 closes the upper molds 168 upon the lower mold 170 to form the mold cavity 172 (FIG. 24). Some or all of the molds 168, 170 may have freedom of movement beyond that which is required to close the molds 168, 170. The additional freedom of movement allows the molds 168, 170 to self align themselves and better form the mold cavity 172. Alternatively, the molds 168, 170 may not have this additional freedom of movement if the assembly 196 offers sufficient precision to properly form the mold cavity 172. The resin injector 180 has an injector port 182 into the mold cavity 172 for injecting resin around the fiber 18 (not shown). The resin injector has a needle valve 184 to control the flow of resin into the mold cavity 172. The needle valve 184 may only open when resin is injected into the mold cavity 172. When the resin is cured, the needle valve 184 is closed, ensuring that the resin in the resin injector 180 and injector port 182 is not cured. The recoating assembly 196 has energy couplers 186 that couple energy from a energy sources 176 (shown in FIGS. 20 and 21) and direct it onto lower mirrors 188. The lower mirrors 188 reflect the energy to upper mirrors 190 that reflect the energy towards the mold cavity 172, where the energy cures the resin surrounding the device 20. Also, energy may be delivered via alternate pathways, for example, direct lamps or fiber guides.

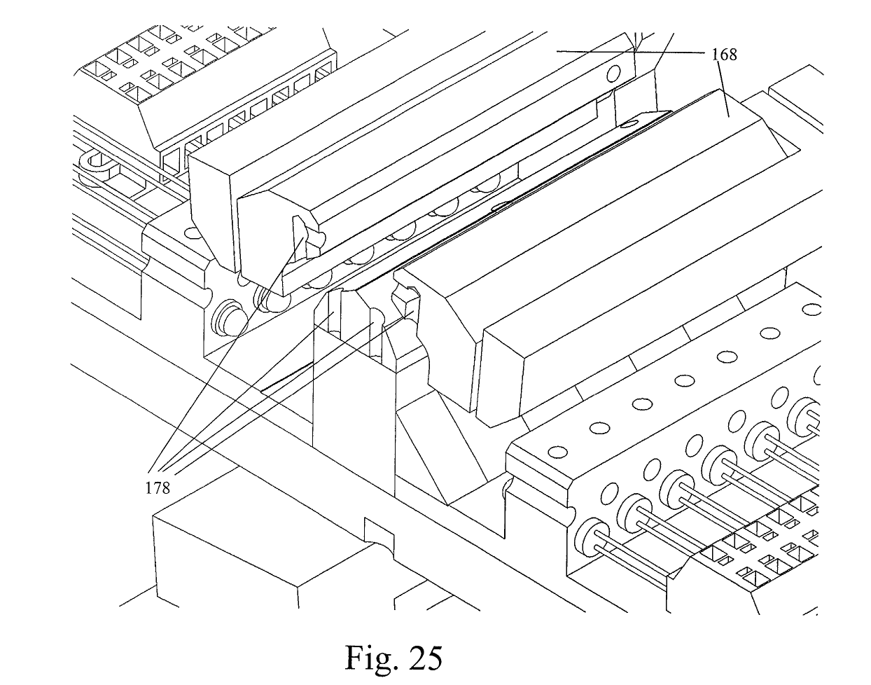

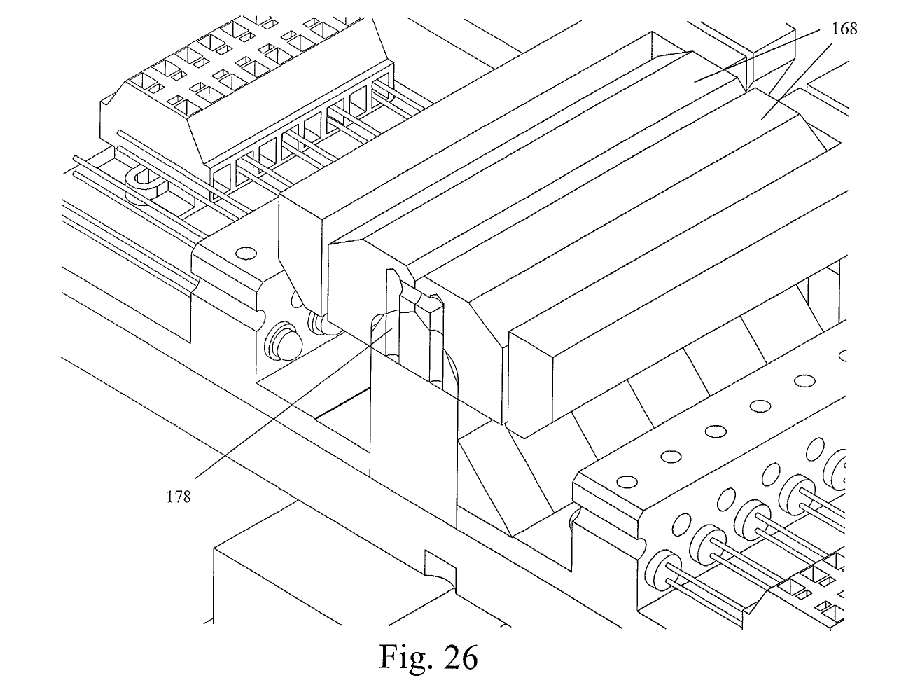

FIGS. 25 and 26 show a cross-section view of the open and closed molds 168, 170. The each of the molds has a continuity channel 178. When the molds 168, 170 close properly, they align and seal the continuity channel 178. Also, the molds 168, 170 may have additional continuity channels 178 to ensure proper alignment.

In one embodiment, the recoating assembly 196 may operate as follows. A tension assembly 70 places the fiber 18 under tension. The recoating assembly 196 uses the fiber guides 174 to guide and align the fiber 18 into the lower mold 170. The upper molds 168 close, forming the mold cavity 172 around the fiber 18. The recoating work station 108 places the continuity channel 178 under pressure. If the pressure holds, the mold is properly sealed and recoating may begin. Otherwise, the mold may be opened and closed again or checked prior to recoating to ensure proper alignment. The self aligning features of the molds and the alignment check results in improved recoating of the device 20. The resin injector 180 injects resin into the mold cavity 172. The needle valve 184 closes the injector port 182 to prevent the curing of resin in the injector port 182. The energy source 176 emits energy that is coupled and reflected to the resin filled mold cavity 172. The energy cures the resin. Finally, the recoating assembly 196 opens the upper molds, releasing the recoated device 20. Also, the intensity of the energy used to cure the resin may be varied during the curing process to decrease the shrinkage of the resin. For example, the intensity of the energy source 176 may be increased during the curing process.

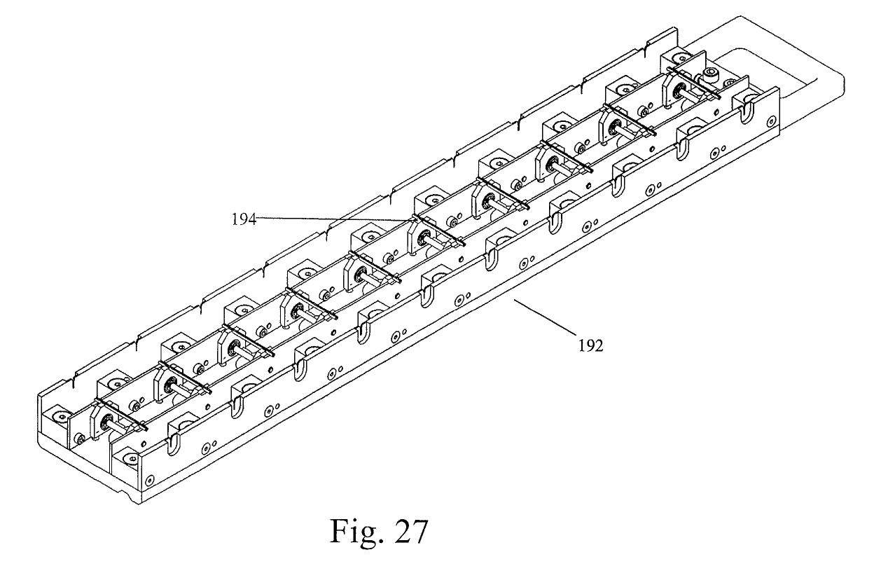

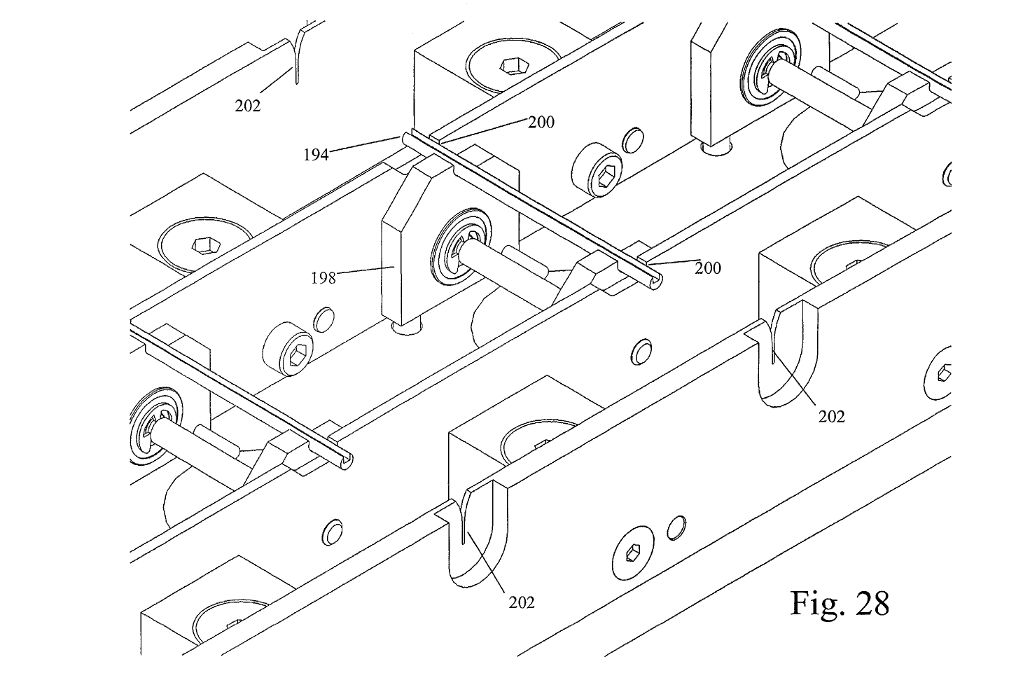

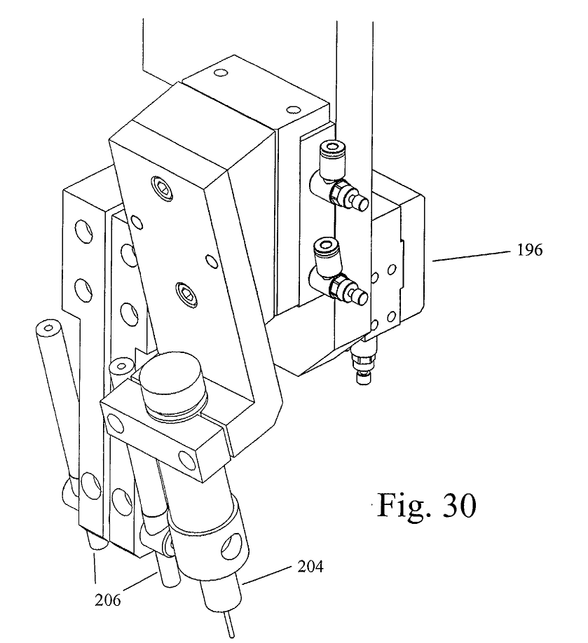

A packaging work station 110 packages the device 20 by attaching the fiber 18 to a package 194 (see FIGS. 27 and 28) with adhesive. A packaging fixture 192 (see FIGS. 27 and 28) hold packages 194 for processing by the packaging work station 110. A device 20 may be packaged so that there is a predetermined tension on the device 20 because tension on a device 20 affects the device characteristics, such as shifts in the reflection wavelength of a FBG. Therefore, the packaging work station 110 may have to control the tension of the fiber 18. The packaging work station 110 can use a tension assembly 70 as previously described. The packaging work station 110 may mount the gripper assembly 72 on a friction free air bearing 164 and may use servo control to set the tension to the desired value. The packaging work station 110 may also include an adhesive assembly 196 (see FIG. 30) that may apply and cure adhesive. The packaging work station 110 may have multiple tension assemblies 70 and adhesive assemblies 166 so that multiple devices 20 may be packaged concurrently.

FIGS. 27 and 28 show the packaging fixture 192 for use in a packaging work station 110 for packaging devices 20. The packaging fixture 192 provides a fixed alignment and location between a package 194 and the fiber 18. The packaging fixture 192 has spring loaded retainers 198 that hold the package 194 in place against alignment wall 200. Also, the packaging fixture 192 has alignment grooves 202 that guide the fiber 18 into a fixed location. The relative location of the alignment walls 200 and alignment groves 150 determine how accurately the fiber 18 is placed and aligned in the package 194.

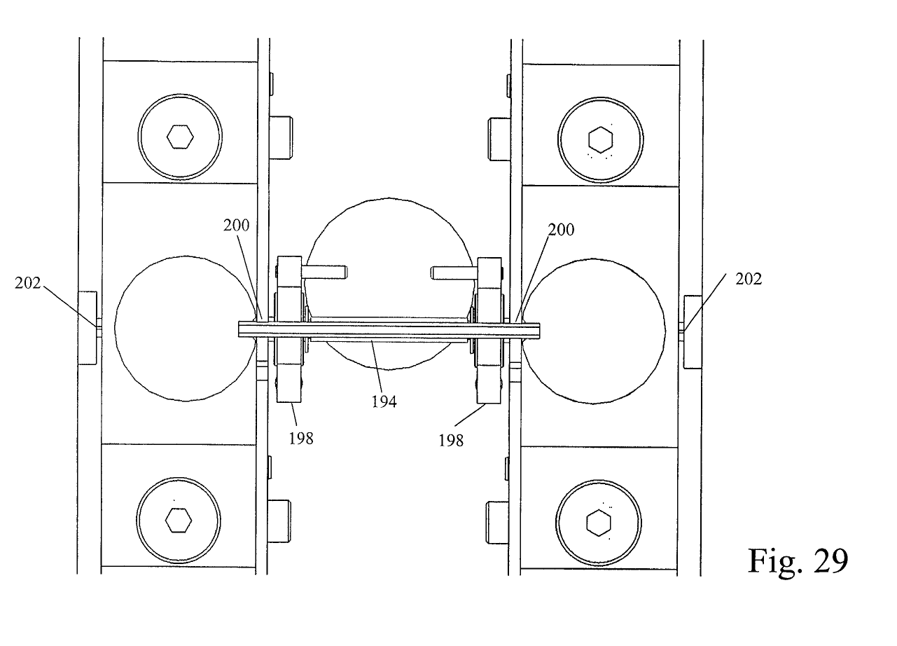

FIG. 29 shows another view of the packaging fixture 192. This view illustrates the alignment between the alignment groove 202 and the package 194 as it is held in place against the alignment walls 200 by the retainers 198.

FIG. 30 shows an adhesive assembly 196 that maybe used in a packaging work station 110. The adhesive assembly 196 has an adhesive dispenser 204 that dispenses adhesive. Also, the adhesive assembly 196 has energy sources 206 that deliver energy to cure the adhesive. The energy sources 206 may use, for example, light energy, RF energy, or thermal energy to cure the adhesive depending on the type of adhesive used.

The packaging workstation 110 may package a device 20 according to the following steps. First, an operator loads packages 194 into the packaging fixture 192. The operator then places the loaded packaging fixture 192 and a magazine 12 containing cassettes 14 in the packaging work station 110. The packaging work station 110 then places the fibers 18 in the fiber guides 150. The fiber guides 150 align the fiber 18 within the package 194. Often the device 20 is packaged so that the device 20 has a predetermined tension, because tension on the fiber 18 may affect device characteristics, such as, the shift of the reflection and/or transmission wavelengths in FBGs. The packaging work station 110 has the gripper assembly 72 grip the fiber 18 and adjust the tension to the predetermined value. In the case of adjusting the tension to zero, the tension can be set to within the control resolution of the packaging work station 110, and to decrease the tension even closer to zero, the grippers 74 slightly release to relieve any residual tension in the fiber 18, but the grippers 74 do not completely let go of the fiber 18. Now, the device 20 may be attached to the package 194.

The packaging work station 110 moves the adhesive assembly 196 to the first attachment point, and the adhesive dispenser 204 places adhesive over the fiber 18. The packaging work station 110 moves the adhesive assembly 196 a fixed distance from the adhesive and turns on the energy source 206 to cure the adhesive. Adhesive shrinkage typically increases the stress on the fiber 18, and hence the tension on the device 20. The packaging work station 110 may reduce adhesive shrinkage by varying the distance between the energy source 206 and the adhesive as a function of time. For example, the energy source 206 may first cure the adhesive for a fixed interval of time at a first distance. Then the packaging work station 110 moves the energy source 206 closer and cures for another interval of time. This can then be repeated for a number of steps. This curing process results in increasing energy intensity as the adhesive cures, which may reduce the shrinkage of the adhesive during curing. Next, the packaging work station 110 moves the adhesive assembly 196 to the other end of the package 194, and the dispenser assembly again dispenses and cures adhesive. Alternatively, the adhesive assembly can also dispense adhesive at both ends of the package 194 and then use both energy sources 206 to cure both adhesives at once.

If the packaging work station 110 has a measurement capability, then additional adjustment of the device 20 characteristics can be accomplished during packaging, because tension on the fiber 18 may affect the device 20 characteristics. For example, tension shifts the reflection and transmission wavelengths of a FBG. While the packaging work station 110 sets the tension of the fiber 18, the packaging work station 110 may measure the device 20 characteristics. If the characteristics of the device 20 need to be adjusted, the packaging work station 110 determines an additional error signal that is used to adjust the tension of the device 20, resulting in the desired characteristics.

A measurement work station 112 provides the ability to measure the characteristics of the devices 20 at any point of the manufacturing process. Some work stations may have to measure the device 20 during processing, so those work stations should have a measurement capability. On the other hand, other work stations my not have to measure the device 20 during processing, so those work stations may not have a measurement capability. The measurement work station 112 may heat the device 20 to a known temperature and then measure the device 20 via the measurement ports 30 in the cassette 14. Also, the measurement work station 112 may use a tension assembly 70 to place a known tension on the fiber 18 during the measurement.

A baking oven 114 bakes the devices 20 after they are packaged. It is desirable to have the devices 20 baked in the cassettes 14 in order to minimize the handling of the fiber 18. Typical baking temperatures are 70°-110° C., so the cassettes 14 should be made from materials that can withstand those temperatures if baking is required. After the fibers 18 are baked, the measurement work station 112 may measure the devices 20 to determine if the devices 20 are still with in specification.

A manufacturing control system 120 (see FIG. 13) controls the overall manufacturing of the devices 20. The manufacturing control 120 system may be implemented as software running on a computer system. The manufacturing control system 120 may also have a network 122 connecting the computer system to work stations to be controlled. The computer system may be a stand alone computer, or it may be distributed across computers found in each work station.

A machine readable identifier may be affixed to each cassette 14 and magazine 12 that facilitates the control of the manufacturing process. The machine readable identifier could be, for example, a bar code, data matrix, or alphanumeric. The identifier allows for each device 20 to be tracked throughout the manufacturing process and for the collection and storage of information relating to the device 20. The machine readable identifier also allows the manufacturing control system 120 to automatically convey the magazines 12 and cassettes 14 from work station to work station when the manufacturing process employs a conveyor system. The manufacturing control system 120 may use the conveyor system to control what work stations operate on a specific magazine 12 and cassette 14.

Each device 20 may be assigned a unique ID number. Further identifying information may include, for example, fiber type, fiber lot, device type, reflection wavelength, reflection bandwidth, pass band ripple, pass band roll off, and sidelobe level. This information may be captured in a device database. Each work station may determine the process parameters for each device based upon identifying information for the device 20. These process parameters are included in a database as part of the manufacturing control process. Specifications for devices to be manufactured can be input into the database and used to derive the process parameters to manufacture the device.

The work stations measure the devices 20 throughout the manufacturing process, and the manufacturing control system 120 captures that data in the device database. Also, the manufacturing control system 120 can analyze the measured data and modify existing process parameters. For example, different lots of the same fiber type may have a varying reflection wavelength versus temperature characteristic. Therefore, during annealing, the annealing work station 106 may compensate for these variations resulting in better reflection wavelength characteristics. In addition, the manufacturing control system 120 may contain process parameters that depend upon the specific work stations. For example, if there are multiple packaging work stations, each may use different parameters for adhesive curing based upon variations in the results obtained by the different work stations. The work station specific parameters may be stored in the manufacturing control system 120 or locally on the work station.

During the manufacturing process, if a device 20 fails a test, the manufacturing control system 120 records information related to the failure. These failures can later be analyzed to identify problems in the manufacturing process. Also, the manufacturing control system 120 identifies the operator during the various manufacturing steps, so operator problems can be identified and corrected. During annealing if, for example, a FBG produces with a reflection wavelength that is outside of the specified value, the manufacturing control system can determine if the FBG now fits or can be made to fit the specification for another FBG type. This results in greater yields.

The manufacturing control system 120 also allows the data collected to be viewed and analyzed in many different ways. For example, the manufacturing control system 120 may generate daily yields or device yields, daily throughput, or failure types. The manufacturing control system 120 may also perform statistical analysis of various device performance characteristics, for example, bandwidth, reflection wavelength, sidelobe levels, and pass band ripple. In addition, the manufacturing control system 120 allows an operator to determine where any given device 20 is in the manufacturing process.

Many variations and modifications can be made to the present invention without departing from its scope. For example, all the work stations may operate on single cassettes 14 instead of a magazine 12. It is also possible for some work stations to operate only on single cassettes 14, while other work stations work on cassettes 14 loaded into magazines 12. Also, portions of the manufacturing process may be partially automated by using a mechanical assist to carry out manual operations. Many other variations, modifications, and combinations are taught and suggested by the present invention, and it is intended that the foregoing specification and the following claims cover such variations, modifications, and combinations.

What is claimed is:

1. A system for manufacturing an optical fiber device comprising:
a fiber magazine
a plurality of fiber cassettes within the magazine, the cassettes including alignment members and optical fiber in which the device is to be manufactured; and
a plurality of work stations including assemblies for processing the fiber in the cassettes, and including alignment members corresponding to the alignment members of the cassettes.

2. The system of claim 1, wherein the magazine includes a plurality of supports corresponding to and engaging the cassettes, and wherein the supports are biased in a first position when engaged with the cassettes.

3. The system of claim 1, wherein the supports are movable to a second position when the cassettes are processed by the assemblies.

4. The system of claim 1, wherein a first portion of less than all cassettes are processed at a first time, and remaining cassettes in the magazine are processed at a second, later time.

5. The system of claim 4, wherein the first portion is half of the cassettes.

6. The system of claim 1, wherein at least one of the work stations includes a number of assemblies equal to half of the number of cassettes that can be held in the magazine.

7. The system of claim 6, wherein the work station can engage the magazine in a first position and in a second position, wherein the first position aligns half of the cassettes in the magazine with the assemblies, and wherein the second position aligns remaining cassettes with the assemblies.

8. The system of claim 1, wherein:
the cassettes include a plurality of measurement ports; and
at least one of the work stations includes at least one measurement port corresponding to the measurement ports on the cassettes.

9. The system of claim 1, wherein the cassettes maintain the fiber in a known position during processing.

10. The system of claim 1, wherein each cassette includes a plurality of grippers for mechanically engaging the fiber to maintain the fiber in a known position during processing.

11. A method of manufacturing optical fiber devices, comprising aligning a plurality of optical fibers with a corresponding plurality of processing assemblies;
engaging the fibers with the assemblies;
processing the fibers;
disengaging the fibers from the assemblies.

12. The method of claim 11, wherein:
aligning includes aligning all fibers;
engaging includes engaging all fibers concurrently;
processing includes processing all fibers concurrently; and
disengaging includes disengaging all fibers concurrently.

13. The method of claim 11, wherein:
aligning includes aligning a first plurality of fibers with the processing assemblies, wherein the first plurality of fibers is less than all of the fibers;
engaging includes engaging the first plurality of fibers at a first time;
processing includes processing the fist plurality of fibers concurrently; and
disengaging includes disengaging the first plurality of fibers concurrently.

14. The method of claim 13, further comprising after disengaging the first plurality of fibers:
aligning a second plurality of fibers with the processing assemblies, wherein the second plurality of fibers includes less than all of the fibers and does not include the first plurality of fibers;
engaging the second plurality of fibers with the assemblies;
processing the second plurality of fibers; and
disengaging the second plurality of fibers from the assemblies.

15. The method of claim 14, wherein aligning the second plurality of fibers includes moving the first plurality of fibers and the second plurality of fibers relative to the assemblies.

16. The method of claim 14, wherein aligning the second plurality of fibers includes moving the assemblies relative to the first plurality of fibers and the second plurality of fibers.

17. The method of claim 14, wherein at least one of the first plurality of fibers and the second plurality of fibers is equal in number to the assemblies.

18. The method of claim 11, wherein engaging includes moving the fibers to the assemblies.

19. The method of claim 11, wherein engaging includes moving the assemblies to the fibers.

20. The method of claim 11, further comprising after disengaging the fibers:
aligning the fibers with an other corresponding plurality of processing assemblies;
engaging the fibers with the other assemblies;
processing the fibers;
disengaging the fibers from the other assemblies.
